(19) United States
(12) Patent Application Publication
(10) Pub. No.: US 2005/0281039 A1
(43) Pub. Date: Dec. 22, 2005

(54) Warning light with a replaceable lamp

(76) Inventor: Peter Yeh, Tainan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/872,356

(22) Filed: Jun. 22, 2004

(51) Int. Cl. F21V 21/00

(52) U.S. Cl. 362/396

(57) ABSTRACT

A warning light having a replaceable lamp includes a base, a circuit board, two conductive clamping supports and a removable housing. The circuit board is mounted on the base. The conductive lamp supports are mounted on the circuit board, connect electrically to the circuit board and each of the lamp supports has a top end, a bottom end and a clamp device integrally formed at the top end. The clamp device includes multiple resilient clamping fingers complementarily arranged at the top end of the lamp support. The lamp with two prongs is removably mounted on the lamp supports with the prongs being respectively clamped by the clamping fingers of the clamp devices. The removable housing is mounted on the base. Consequently, the lamp is easy to be assembled and replaced because of the resilient clamping fingers.

### BACKGROUND OF THE INVENTION

1. Field of the Invention

The present invention relates to a warning light, and more particularly to a warning light with a replaceable lamp so that either assembling or disassembling the lamp in the warning light is easy and convenient.

2. Description of Related Art

Warning lights are mounted on vehicles or installed on a stand that is located in a dark place to produce a visible warning signal by light to alert people of a hazard. Especially, in the dark place or at night, the warning lights will definitely alert people that there is a dangerous state.

With reference to FIG. 5, a conventional warning light in accordance with the prior art comprises a base (60), a circuit board (61), two conductive lamp supports (62), a lamp (63) and a removable housing (65).

The base (60) has a top on which the circuit board (61) is mounted. The lamp supports (62) are mounted on the circuit board (61) and transmits electricity provided by the circuit board (61) to the lamp (63) to light the lamp (63).

The lamp (63) is mounted on the lamp supports (62) and has two conductive prongs (631). The conductive prongs (631) are respectively jointed to the lamp supports (62) with two solder joints (64).

The removable housing (65) is mounted on the top of the base (60) and covers the lamp (63) inside to protect the lamp (63) from being easily damaged.

However, the soldered lamp (63) on the lamp supports (62) is not easy to be replaced unless to melt the solder joints (64). Replacement of the lamp (63) is inconvenient if the lamp (63) is burned or being damaged. In addition, the efficiency of assembling the lamp (63) on the lamp supports (62) is slow due to use of the solder joints (64), and the manufacturing cost for the conventional warning light is raised.

With reference to FIG. 6, another type of conventional warning light in accordance with the prior art comprises a base (70), a circuit board (71), two conductive lamp supports (72), a lamp (73), two hemispherical couplings (74) and a removable housing (76).

The base (70) has a top on which the circuit board (71) is mounted. The lamp supports (72) are mounted on the circuit board (71) and transmits electricity provided by the circuit board (71) to the lamp (73) to light the lamp (73).

The hemispherical couplings (74) are respectively attached to the lamp supports (72) and face each other. Each of the hemispherical couplings (74) has a mounting tube (75). The mounting tubes (75) are respectively attached to the lamp supports (72).

The lamp (73) is mounted on and between the hemispherical couplings (74) and has two conductive prongs (731). The conductive prongs (731) are respectively held in the mounting tubes (75) to retain the lamp (73) in position and provide a path of electricity transmission between the lamp (73) and the lamp supports (72).

The removable housing (76) is mounted on the top of the base (70) and covers the lamp (73) inside to protect the lamp (73) from being easily damaged.

Even though the second conventional warning light provides a capability of replacing the lamp (73) when the lamp (73) is burned, it still has some problems. Using the hemispherical couplings (74) needs additional machining processes to fabricate the hemispherical couplings (74), which will increase manufacturing costs. Besides, the solder joints are still needed to connect the mounting tubes (75) of the hemispherical couplings (74) onto the respective lamp supports (72) before assembling the lamp (73). Assembling the lamp (73) in the second conventional warning light is also slow.

To overcome the shortcomings, the present invention provides a warning light that has a replaceable lamp that is quickly either assembled or disassembled in the warning light to mitigate or obviate the aforementioned problems.

### SUMMARY OF THE INVENTION

The main objective of the invention is to provide a warning light having a replaceable lamp, and the warning light has multiple resilient clamping fingers to hold the lamp so that either to assemble or to disassemble the lamp is quick, convenient and easy.

A warning light having a replaceable lamp in accordance with the present invention includes a base, a circuit board, two conductive clamping supports and a removable housing. The circuit board is mounted on the base. The conductive lamp supports are mounted on the circuit board, connect electrically to the circuit board and each of the lamp supports has a top end, a bottom end and a clamp device integrally formed at the top end. The clamp device includes multiple resilient clamping fingers complementarily arranged at the top end of the lamp support. The lamp with two prongs is removably mounted on the lamp supports with the prongs being respectively clamped by the clamping fingers of the clamp devices. The removable housing is mounted on the base. Consequently, the lamp is easy to be assembled or replaced because of the resilient clamping fingers.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a warning light in accordance with the present invention;

FIG. 2 is an exploded perspective view of two conductive lamp supports and a lamp of the warning light in FIG. 1;

FIG. 3 is an enlarged side elevational view of the conductive lamp supports and the lamp in FIG. 2 when the lamp is mounted on the conductive lamp supports;

FIG. 4 is an enlarged side elevational view of an alternative embodiment of conductive lamp supports and a lamp in accordance with the present invention when the lamp is mounted on the conductive lamp supports;

FIG. 5 is an exploded perspective view of a conventional warning light in accordance with the prior art; and

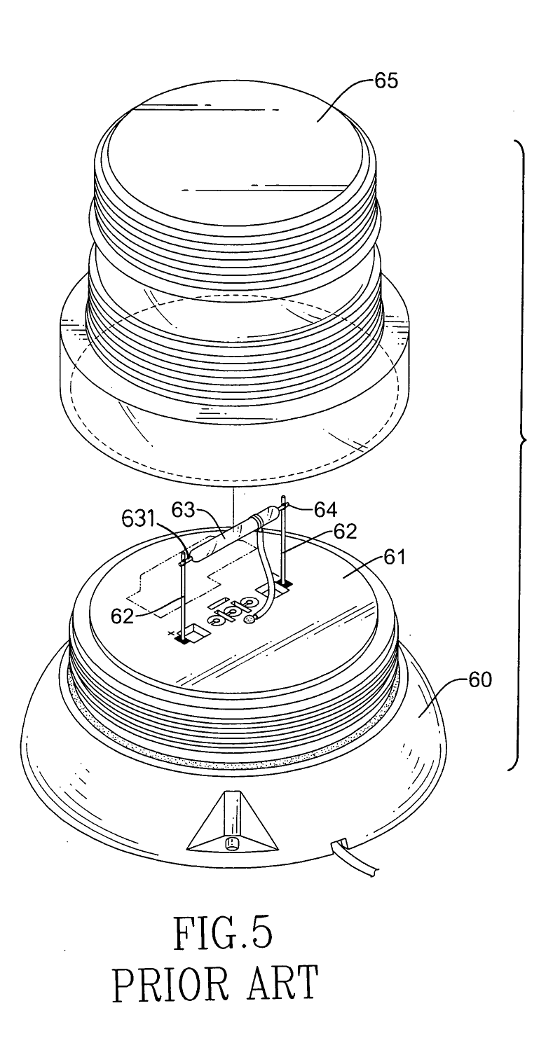

FIG. 6 is an exploded perspective view of another type of conventional warning light in accordance with the prior art.

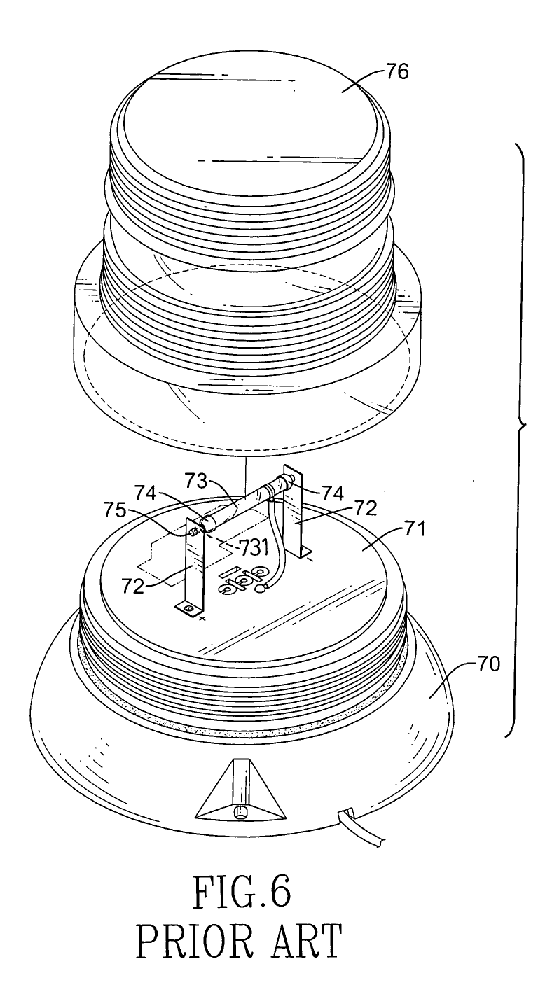

### DETAILED DESCRIPTION OF PREFERRED EMBODIMENT

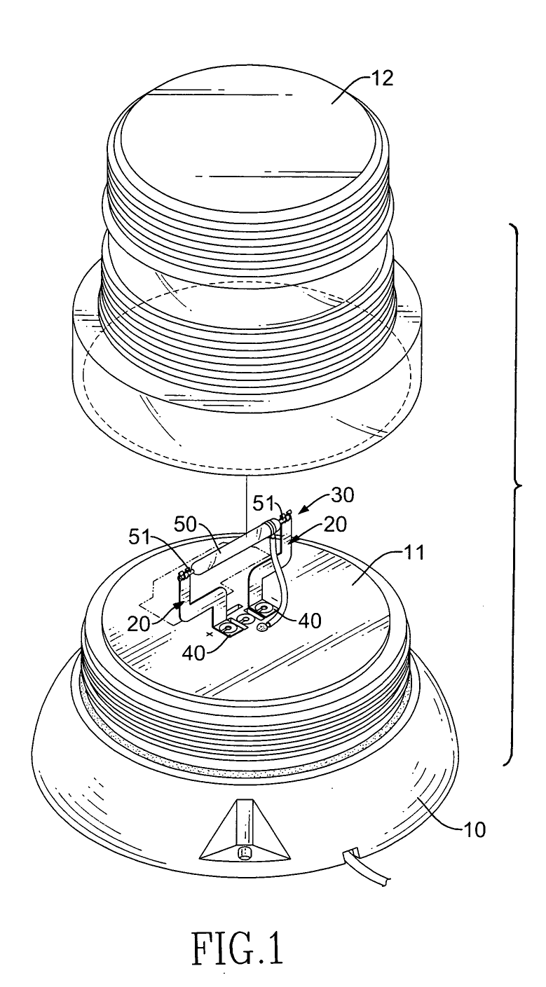

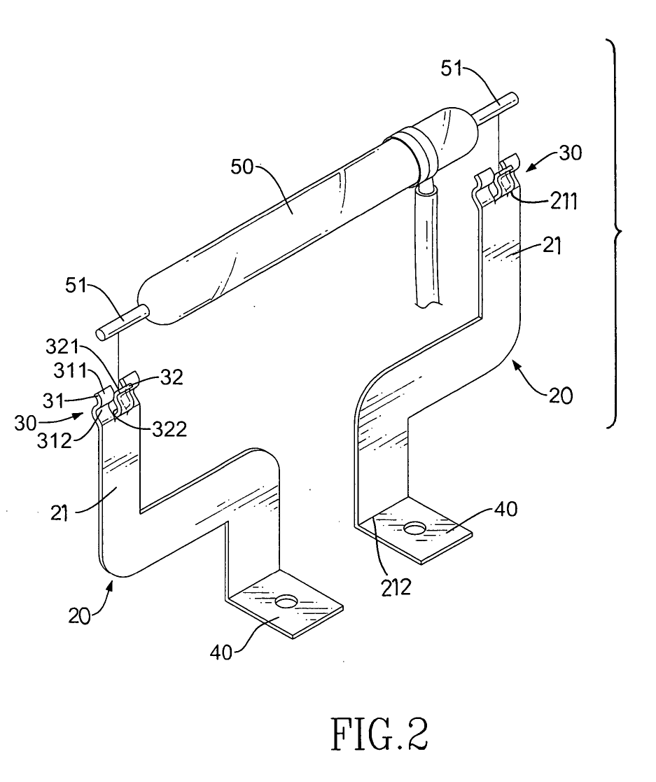

With reference to FIGS. 1 and 2, a warning light in accordance with the present invention comprises a base (10), a circuit board (11), two conductive lamp supports (20), a lamp (50) and a removable housing (12).

The base (10) has a top on which the circuit board (11) is mounted. The lamp supports (20) are made of conductive materials and are mounted on the circuit board (11) to transmit electricity provided by the circuit board (11) so as to light the lamp (50). Each of the lamp supports (20) comprises a mounting foot (40), a supporting arm (21) and a clamp device (30).

The supporting arm (21) is bent like a Z-shape and has a top end (211) and a bottom end (212). The clamp device (30) and the mounting foot (40) are integrally formed at the respective top and the bottom ends (211, 212) by forging or bending. The mounting foot (40) is bent at the bottom end (212) of the supporting arm (21) and is perpendicular to the supporting arm (21). The clamp device (30) is formed at the top end (211) of the supporting arm (21) and comprises multiple resilient clamping fingers including two first clamping fingers (31) and a second clamping finger (32). An amount of the clamping fingers (31, 32) can be modified and depends on practical needs.

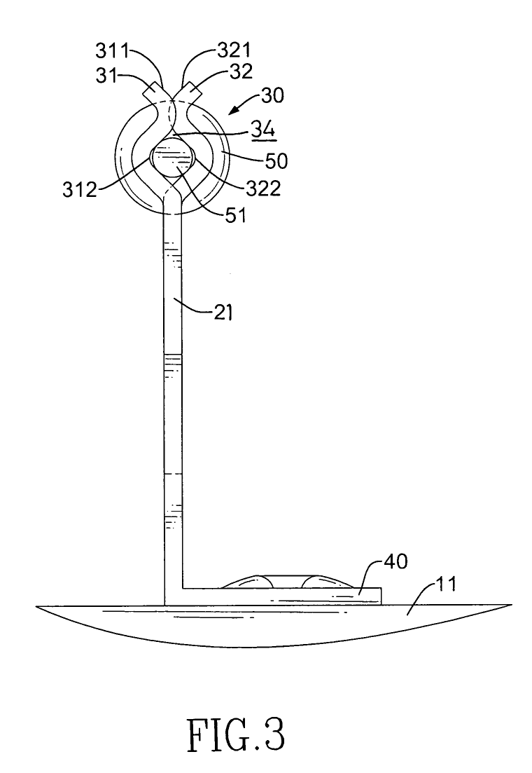

With further reference to FIG. 3, the first and the second clamping fingers (31, 32) are complementarily arranged on the top end (211) of the supporting arm (21), and each of them has a curved guiding segment (311, 312) and a sharp bend (312, 322). The curved guiding segments (311, 312) are respectively extended toward opposite directions. The sharp bends (312, 322) of the clamping fingers (31, 32) correspond to each other to define a space (34) to hold the lamp (50).

The lamp (50) is clamped and held by the clamp devices (30) on the supporting arms (21) and has two conductive prongs (51). The prongs (51) are cylindrical, are respectively held in the spaces (34) and are clamped by the clamping fingers (31, 32) of the clamp devices (30). Assembling the lamp (50) on the supporting arms (21) is quick and easy. The prongs (51) will slide along the curved guiding segments (311, 312) to separate the clamping fingers (31, 32) and slip into the corresponded sharp bends (312, 322) of the clamping devices (30) when the lamp (50) is pushed downward. The resilient clamping fingers (31, 32) of the clamp devices (30) position respectively the prongs (51) in the spaces (34) surrounded by the corresponding sharp segments (312, 322) of the first and the second clamping fingers (31, 32). Replacing the lamp (50) from the supporting arms (21) is also quick and easy. A person can push the clamping fingers (31, 32) outward through the curved guiding segments (311, 321) to separate the sharp bends (312, 322) apart from each other, thus the lamp (50) can be easily removed from the supporting arms (21).

The removable housing (12) is mounted on the top of the base (10) and covers the lamp (50) inside to protect the lamp (50) from being easily damaged.

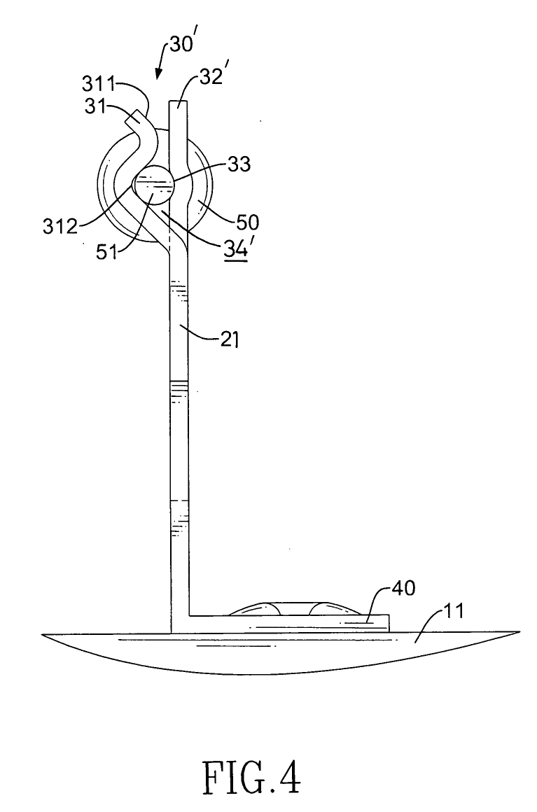

With reference to FIG. 4, an alternative embodiment of a clamp device (30′) comprises multiple resilient clamping fingers including two first clamping fingers (31) and a second clamping finger (32′). The first and the second clamping fingers (31, 32′) are complementarily arranged on the supporting arm (21). Each of the first clamping fingers (31) has a curved guiding segment (311) and a sharp bend (312). The curved guiding segments (311) are extended toward a direction opposite to the second clamping finger (32′). The second clamping finger (32′) has a recess (33) corresponding to the sharp bends (312), whereby the recess (33) cooperates with the sharp bend (312) defining a space (34′) that will firmly hold one of the prongs (51) of the lamp (50) in position.

Therefore, not only to assemble but also to disassemble the lamp (50) is quick and convenient because of the resilient clamping fingers (31, 32, 32′). The clamp deices (30, 30′) are integrated formed on the supporting arms (21) by forging or bending so that any additional parts to connect the prongs (51) of the lamp (50) is unnecessary.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the scope of the appended claims.

1. A warning light comprising
a base;
a circuit board mounted on the base;
two conductive lamp supports mounted on the circuit board, connected electrically to the circuit board and each of the lamp supports having
a top end;
a bottom end; and
a clamp device integrally formed at the top end and comprising multiple resilient clamping fingers complementarily arranged at the top end;
a lamp with two conductive prongs removably mounted on the lamp supports; and
a removable housing mounted on the base;
wherein each of the prongs of the lamp is clamped by the clamping fingers of a respective one of the clamp devices.

2. The warning light as claimed in claim 1, wherein the clamping fingers of each of the clamp devices comprises two first clamping fingers and a second clamping finger, each of the first clamping fingers has a curved guiding segment and a sharp bend, and the second clamping finger has a curved guiding segment and a sharp bend, wherein the curved guiding segments of the first clamping fingers and the curved guiding segment are respectively extended toward opposite directions and the sharp bends of the first clamping fingers and the sharp bend of the second clamping finger correspond to each other to define a space to receive a respective one of the prongs of the lamp.

3. The warning light as claimed in claim 1, wherein the clamping fingers of each of the clamp devices comprises two first clamping fingers and a second clamping finger, each of the first clamping fingers has a curved guiding segment extended toward a direction opposite to the second clamping finger and a sharp bend, and the second clamping finger has a recess corresponding to the sharp bends;
wherein the recess cooperates with the sharp bends to define a space to receive a respective one of the prongs of the lamp in position.
